(19) United States
(12) Patent Application Publication
(10) Pub. No.: US 2017/0076139 A1
(43) Pub. Date: Mar. 16, 2017

(54) METHOD OF CONTROLLING MOBILE TERMINAL USING FINGERPRINT RECOGNITION AND MOBILE TERMINAL USING THE SAME

(71) Applicant: Samsung Electronics Co., Ltd, Gyeonggi-do (KR)

(72) Inventors: IL-kwon Park, Gyeonggi-do (KR); Woo-ram Son, Seoul (KR); Seong-hyun Kim, Gyeonggi-do (KR); Soon-ae Kim, Gyeonggi-do (KR); Pil-soo Kim, Gyeonggi-do (KR); Seon-jeong Lee, Gyeonggi-do (KR); Dong-jin Jung, Seoul (KR); Myoung-kyoung Jeong, Gyeonggi-do (KR); Sung-ki Jin, Gyeonggi-do (KR)

(21) Appl. No.: 15/310,758

(22) PCT Filed: Apr. 7, 2015
(86) PCT No.: PCT/KR2015/003444

§ 371 Date: Nov. 12, 2016

(30) Foreign Application Priority Data
May 13, 2014 (KR) 10-2014-0057449

(51) Int. Cl. G06K 9/00

(52) U.S. Cl. CPC G06K 9/00087; G06K 9/00926; G06K 9/00382; G06K 2009/00953

(57) ABSTRACT

Provided are a method and an apparatus for providing an efficient user interface(UI) to a user by using fingerprint recognition. A method of controlling a mobile terminal includes: registering a plurality of fingerprint signatures for a fingerprint data-basic; generating fingerprint image data by using a fingerprint recognition module included in the mobile terminal; determining a fingerprint signature that corresponds to the fingerprint image data, from among the plurality of fingerprint signatures; and executing a process corresponding to the determined fingerprint signature.

### TECHNICAL FIELD

One or more exemplary embodiments relate to a method of controlling a mobile terminal by using fingerprint recognition and a mobile terminal using the same, and more particularly, to a method and apparatus for providing various user interfaces (UIs) by using fingerprint recognition.

### BACKGROUND ART

Recently, as digital technology advances, mobile terminals are widely used and various services using mobile terminals are provided. A mobile terminal may refer to a small and light device that is configured to be carried by a user. The mobile terminal has various functions that may be provided by a personal computer (PC), such as communication, games, multimedia services, or the like. For example, the mobile terminal may include a smartphone, a tablet PC, a personal digital assistant (PDA), a laptop computer, a smart watch, or the like, but is not limited thereto.

Generally, mobile terminals include an information input unit that may receive information from a user. For example, a mobile terminal may include a plurality of input keys. However, since the mobile terminal is small, it may be difficult to efficiently dispose the plurality of input keys on the mobile terminal. Thus, recently, a touchscreen is widely used as an input unit. For example, a method of using a virtual keyboard input is used as an information input unit included in the mobile terminal. According to the method of using the virtual keyboard input, if a user contacts a location, on which a key desired by the user is displayed, with a part of his/her physical body or with a stylus, the mobile terminal may receive an input of a value corresponding to the key. Additionally, a size of a touchscreen included in the mobile terminal is increasing. Accordingly, it may be necessary to provide a user with an efficient user interface (UI) so that the user may easily control the mobile terminal while the user is holding the mobile terminal with one hand.

Additionally, various sensors may be applied to the mobile terminal. Particularly, a fingerprint recognition sensor for recognizing a fingerprint of a user has been included in the mobile terminal recently. Thus, it may be necessary to provide an efficient UI by using the fingerprint recognition sensor.

### DISCLOSURE OF INVENTION

### Technical Problem

One or more exemplary embodiments include a method and apparatus for providing a user with an efficient user interface (UI) by using fingerprint recognition.

### Solution to Problem

Additional aspects will be set forth in part in the description which follows and, in part, will be apparent from the description, or may be learned by practice of the presented exemplary embodiments.

According to one or more exemplary embodiments, a method of controlling a mobile terminal includes: registering a plurality of fingerprint signatures for a fingerprint database; generating fingerprint image data by using a fingerprint recognition module included in the mobile terminal; determining a fingerprint signature that corresponds to the fingerprint image data, from among the plurality of fingerprint signatures; and executing a process corresponding to the determined fingerprint signature.

### Advantageous Effects of Invention

An efficient user interface (UI) is provided to a user by using fingerprint recognition.

### BRIEF DESCRIPTION OF DRAWINGS

These and/or other aspects will become apparent and more readily appreciated from the following description of the exemplary embodiments, taken in conjunction with the accompanying drawings in which:

FIG. 1 illustrates a schematic block diagram of a structure of a mobile terminal according to some exemplary embodiments;

FIG. 2 illustrates a block diagram of a structure of the mobile terminal according to some exemplary embodiments;

FIG. 3 illustrates a conceptual diagram of the mobile terminal according to some exemplary embodiments;

FIG. 4 illustrates a flowchart of a process of controlling the mobile terminal according to some exemplary embodiments;

FIGS. 5A and 5B illustrate conceptual diagrams of a user interface (UI) that is output by the mobile terminal to register a fingerprint, according to some exemplary embodiments;

FIG. 6 illustrates a conceptual diagram of a fingerprint signature registered for a fingerprint database, according to some exemplary embodiments;

FIG. 7 illustrates a flowchart of a method of recognizing a fingerprint and displaying a UI corresponding to the fingerprint, according to some exemplary embodiments;

FIGS. 8 through 10 illustrate conceptual diagrams of the mobile terminal for to displaying a UI, according to some exemplary embodiments;

FIGS. 11 through 13 illustrate conceptual diagrams of the mobile terminal for displaying an application execution screen, according to some exemplary embodiments;

FIGS. 14 and 15 illustrate conceptual diagrams of a manipulation area according to other exemplary embodiments;

FIG. 16 illustrates a conceptual diagram of a method of determining a direction of a recognized fingerprint, according to some exemplary embodiments;

FIG. 17 illustrates a conceptual diagram of the mobile terminal for displaying a UI, according to some exemplary embodiments; and

FIG. 18 illustrate conceptual diagrams of a method of executing a process corresponding to a state of the mobile terminal and a recognized finger print, the method being performed by the mobile terminal, according to some exemplary embodiments.

### BEST MODE FOR CARRYING OUT THE INVENTION

According to one or more exemplary embodiments, a method of controlling a mobile terminal includes: registering a plurality of fingerprint signatures for a fingerprint database; generating fingerprint image data by using a fingerprint recognition module included in the mobile terminal; determining a fingerprint signature that corresponds to the fingerprint image data, from among the plurality of fingerprint signatures; and executing a process corresponding to the determined fingerprint signature.

The registering of the plurality of fingerprint signatures may comprise registering the plurality of fingerprint signatures by differentiating a fingerprint of a left hand from a fingerprint of a right hand, and the executing of the process corresponding to the determined fingerprint signature may comprise: executing a first process if the determined fingerprint signature is the fingerprint of the left hand; and executing a second process if the determined fingerprint signature is the fingerprint of the right hand, wherein the first process and the second process are different from each other.

The executing of the process corresponding to the determined fingerprint signature may comprise: determining a manipulation area of a display unit included in the mobile terminal, based on the determined fingerprint signature; and displaying a user interface (UI), via which a user inputs a command to the mobile terminal, on the determined manipulation area.

The determining of the manipulation area may comprise determining the manipulation area based on a direction of a fingerprint included in the fingerprint image data.

The determining of the manipulation area may comprise rotating a fingerprint in the fingerprint image data in various angle and comparing the rotated fingerprint to the plurality of fingerprint signatures, obtaining a correlation value with respect to a correlation between the rotated fingerprint and each of the plurality of fingerprint signatures based on a result of the comparing, and determining a rotation angle of a fingerprint having a highest correlation value as a direction of the fingerprint.

The executing of the process corresponding to the determined fingerprint signature may comprise: determining a manipulation area of the display unit included in the mobile terminal, based on the determined fingerprint signature; and displaying an application execution screen on the manipulation area.

The executing of the process corresponding to the determined fingerprint signature may comprise: determining a process corresponding to a state of the mobile terminal and the determined fingerprint signature; and executing the determined process.

The determining of the process may comprise: executing an application corresponding to the fingerprint signature, if the mobile terminal is in a power-off state; and booting an operating system (OS) of the mobile terminal after the application is executed.

The executing of the process corresponding to the determined fingerprint signature may comprise displaying either a UI in a widthwise mode or a UI in a lengthwise mode on the display unit included in the mobile terminal, according to a direction of a fingerprint included in the fingerprint image data.

According to one or more exemplary embodiments, a mobile terminal includes: a fingerprint database configured to register a plurality of fingerprint signatures; a fingerprint recognition module configured to generate fingerprint image data; a controller configured to determine a fingerprint signature that corresponds to the fingerprint image data, from among the plurality of fingerprint signatures, and execute a process corresponding to the determined fingerprint signature.

The fingerprint database may register the plurality of fingerprint signatures by differentiating a fingerprint of a left hand from a fingerprint of a right hand, and the controller may execute a first process if the determined fingerprint signature is the fingerprint of the left hand, and executes a second process if the determined fingerprint signature is the fingerprint of the right hand, wherein the first process and the second process are different from each other.

The mobile terminal may further comprise a display unit for outputting a screen, wherein the controller determines a manipulation area of a display unit included in the mobile terminal based on the determined fingerprint signature, and displays a user interface (UI), via which a user inputs a command to the mobile terminal, on the determined manipulation area.

The controller may control the display unit to display the UI, via which the user inputs the command to the mobile terminal, on the determined manipulation area.

The controller may rotate a fingerprint in the fingerprint image data in various angle and comparing the rotated fingerprint to the plurality of fingerprint signatures, obtain a correlation value with respect to a correlation between the rotated fingerprint and each of the plurality of fingerprint signatures based on a result of the comparing, and determine a rotation angle of a fingerprint having a highest correlation value as a direction of the fingerprint.

The mobile terminal may further comprise a display unit for outputting an application execution screen, wherein the controller determines a manipulation area of the display unit, based on the determined fingerprint signature and the display unit displays the application execution screen on the determined manipulation area.

The controller may determine a process corresponding to a state of the mobile terminal and the determined fingerprint signature, and execute the determined process.

The controller may execute an application corresponding to the fingerprint signature if the mobile terminal is in a power-off state, and boots an operating system (OS) of the mobile terminal after the application is executed.

The mobile terminal may further comprise a display unit for outputting a screen, wherein the controller controls the display unit to display either a UI in a widthwise mode or a UI in a lengthwise mode according to a direction of the fingerprint included in the fingerprint image data.

A non-transitory computer-readable recording storage medium having stored thereon a computer program, which when executed by a computer, may perform the method.

### Mode for the Invention

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The inventive concept will now be described more fully with reference to the accompanying drawings, in which exemplary embodiments of the inventive concept are shown. The inventive concept may, however, be embodied in many different forms and should not be construed as being limited to the embodiments set forth herein. In the description of the inventive concept, certain detailed explanations of the related art are omitted when it is deemed that they may unnecessarily obscure the essence of the inventive concept. Like numbers refer to like elements throughout the description of the figures.

It will be understood that when an element is referred to as being “connected to” or “coupled to” another element, it may be “directly connected or coupled” to the other element, or “electrically connected to” the other element with intervening elements therebetween. It will be further understood that the terms “comprises”, “comprising”, “includes”, and/or “including” when used herein, specify the presence of components, but do not preclude the presence or addition of one or more other components, unless otherwise specified.

A “touch” or “touch input”, used herein, may include a case when a display apparatus detects a body of a user who is near the display apparatus, for example, within a distance range of 2 cm, as well as a case when the user directly touches the display apparatus. Additionally, a “touch input” may be substituted by another input method, according to an input unit.

Hereinafter, the inventive concept will be described in detail by explaining exemplary embodiments with reference to the attached drawings.

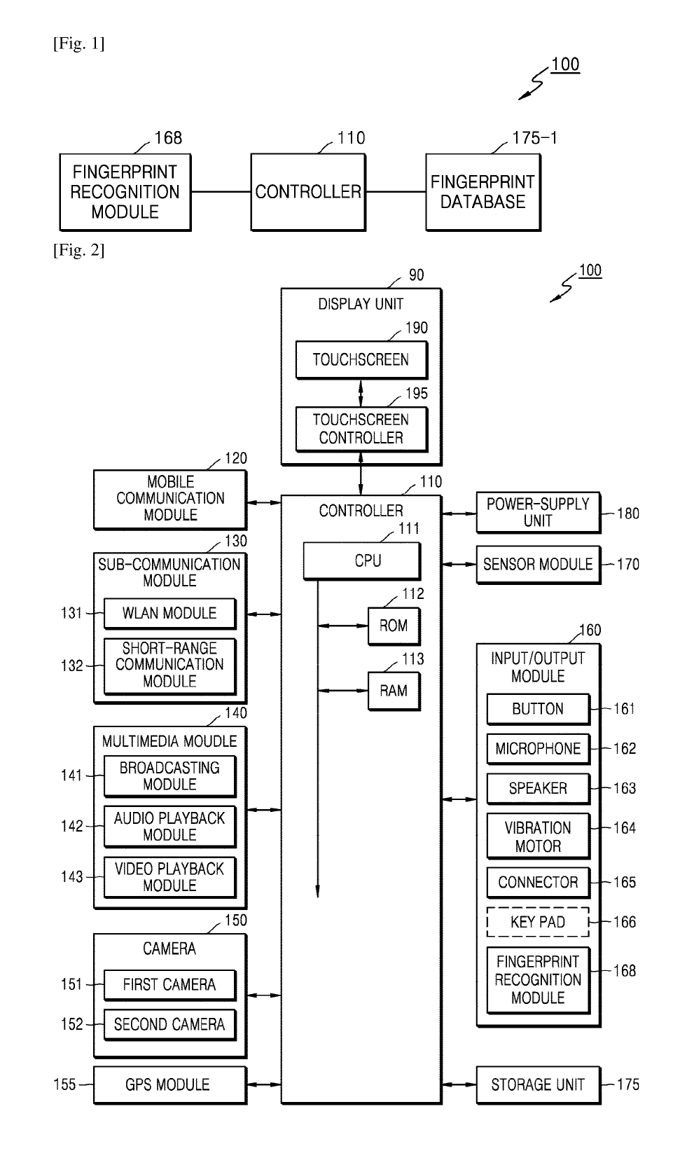

FIG. 1 illustrates a schematic block diagram of a structure of a mobile terminal 100 according to some exemplary embodiments. According to some exemplary embodiment, the mobile terminal 100 may include a fingerprint recognition module 168, a controller 110, and a fingerprint database 175-1. FIG. 1 is provided to describe some exemplary embodiments, and elements shown in FIG. 1 may be omitted or substituted by other elements. Additionally, the mobile terminal 100 may further include elements other than those shown in FIG. 1.

The fingerprint recognition module 168 may include a fingerprint recognition sensor for generating fingerprint image data by recognizing a fingerprint of a user. The fingerprint recognition sensor may be disposed at various locations in the mobile terminal 100. For example, the fingerprint recognition sensor may be located on at least one selected from the group consisting of a home button, a side surface, and a rear surface of the mobile terminal 100. The fingerprint recognition sensor may be implemented as an optical type sensor or a semiconductor-type sensor, but is not limited thereto.

According to some exemplary embodiments, the fingerprint recognition module 168 may compare an electric signal, output when a fingerprint of a user contacts an outer surface of the fingerprint recognition module, to a reference voltage, and generate fingerprint image data consisting of binary data indicating whether the electric signal corresponds to a ridge of the fingerprint or a valley of the fingerprint.

According to some exemplary embodiments, a fingerprint signature for determining a fingerprint corresponding to the fingerprint image data may be registered for the fingerprint database 175-1. The fingerprint database 175-1 may be located physically inside or outside the mobile terminal 100. For example, the fingerprint database 175-1 may be configured to include a storage unit that is located in the mobile terminal 100. Alternatively, the fingerprint database 175-1 may be configured to include a server that is located outside the mobile terminal 100. According to some exemplary embodiment, if a user inputs a fingerprint when the mobile terminal 100 is driven first, the mobile terminal 100 may register the fingerprint as a fingerprint signature for the fingerprint database 175-1. According to another exemplary embodiment, when a fingerprint recognition function of the mobile terminal 100 is performed first, if the user inputs a fingerprint, the mobile terminal 100 may register the input fingerprint as a fingerprint signature for the fingerprint database 175-1. According to another exemplary embodiment, if the user inputs a fingerprint after the user selects a menu provided by the mobile terminal 100, the mobile terminal 100 may register the input fingerprint as a fingerprint signature for the fingerprint database 175-1.

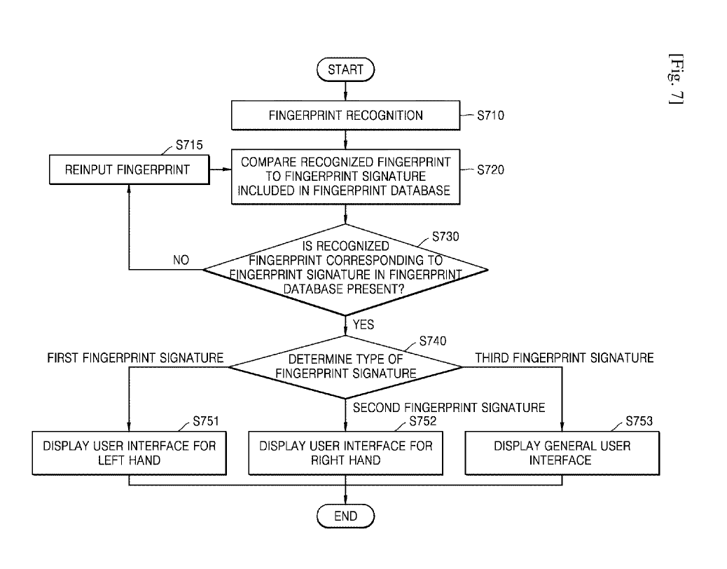

According to some exemplary embodiments, the fingerprint database 175-1 may differentiate a fingerprint signature of a left hand from a fingerprint signature of a right hand so as to register a fingerprint. FIG. 6 illustrates a conceptual diagram of a fingerprint signature registered for the fingerprint database 175-1, according to some exemplary embodiments. “Registering” herein may refer to classifying and storing a fingerprint signature for the fingerprint database 175-1. Referring to FIG. 6, the fingerprint database 175-1 may classify a fingerprint signature according to a finger, and store the fingerprint signature. Additionally, the fingerprint database 175-1 may classify and store fingerprint signatures of a plurality of users. FIG. 6 is provided to describe some exemplary embodiments, and a structure of a fingerprint signature stored by the fingerprint database 175-1 may be variously modified. Although not shown in FIG. 6, according to some exemplary embodiments, the fingerprint database 175-1 may store a command or identification information for identifying a process corresponding to a fingerprint signature.

According to some exemplary embodiments, the controller 110 may determine a fingerprint signature corresponding to the fingerprint image data. The controller 110 may compare the fingerprint image data to each of a plurality of fingerprint signatures registered for the fingerprint database 175-1. The controller 110 may obtain a correlation value with respect to a correlation between the fingerprint image data and each of the plurality of fingerprint signatures, based on a result of the comparing. The correlation value may refer to a value indicating a degree in which the fingerprint image data matches a fingerprint signature. The controller 110 may determine a fingerprint signature having a highest correlation value as a fingerprint signature corresponding to the fingerprint image data.

Additionally, the controller 110 may execute a process corresponding to the determined fingerprint signature. According to some exemplary embodiments, the controller 110 may determine a process to be executed, based on whether the fingerprint signature corresponding to the fingerprint image data is included in a left hand or a right hand. According to other exemplary embodiments, if a process corresponding to the fingerprint signature is stored in the fingerprint database 175-1, the controller 110 may determine a process to be executed, based on the fingerprint database 175-1. A method of determining a process to be executed based on a fingerprint signature, the method being performed by the controller 110, may be variously modified.

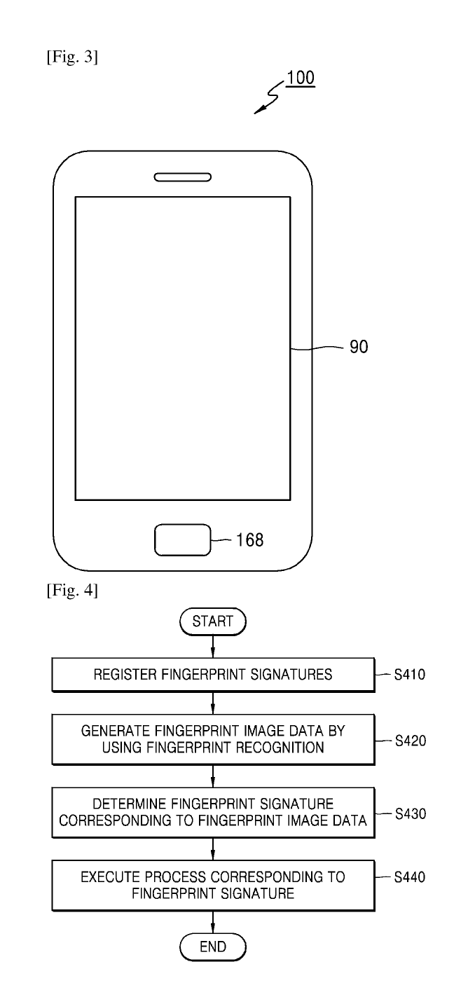

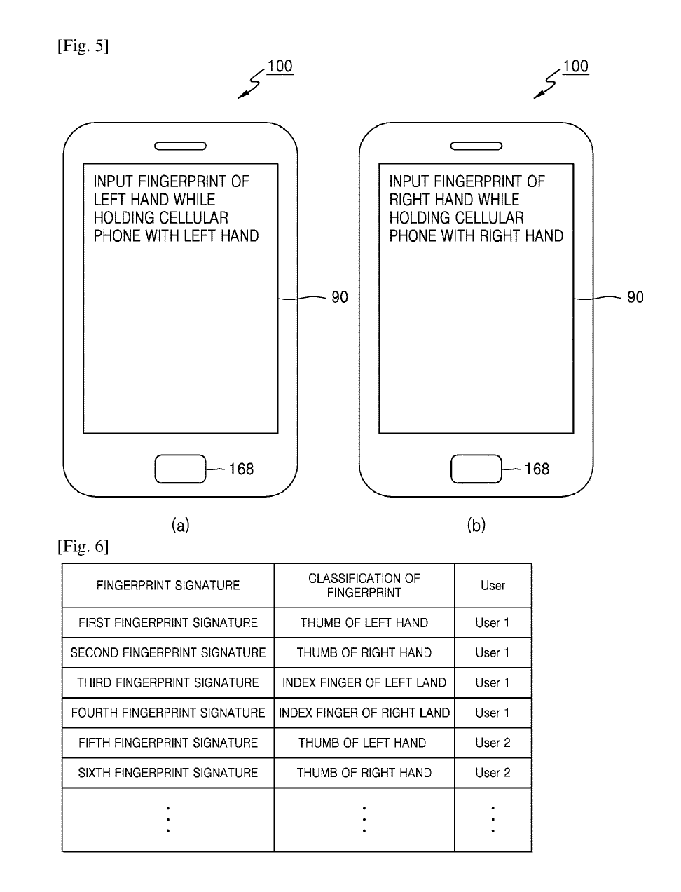

FIG. 3 illustrates a conceptual diagram of the mobile terminal 100 according to some exemplary embodiments. Referring to FIG. 3, the mobile terminal 100 may include a display unit 90 and a fingerprint input module 168. FIGS. 5A and 5B are conceptual diagrams of a user interface (UI) that is output by the mobile terminal 100 to register a fingerprint, according to some exemplary embodiments. As shown in FIG. 5A, the mobile terminal 100 may display a UI requesting a user to hold the mobile terminal 100 with his/her left hand and input a fingerprint of the left hand. After displaying the UI requesting the user to input the fingerprint of the left hand, the mobile terminal 100 may register a fingerprint input to the fingerprint recognition module 168 for the fingerprint database 175-1. Additionally, as shown in FIG. 5B, the mobile terminal 100 may display a UI requesting the user to hold the mobile terminal 100 with his/her right hand and input a fingerprint of the right hand. After displaying the UI requesting the user to input the fingerprint of the right hand, the mobile terminal 100 may register a fingerprint input to the fingerprint recognition module 168 for the fingerprint database 175-1.

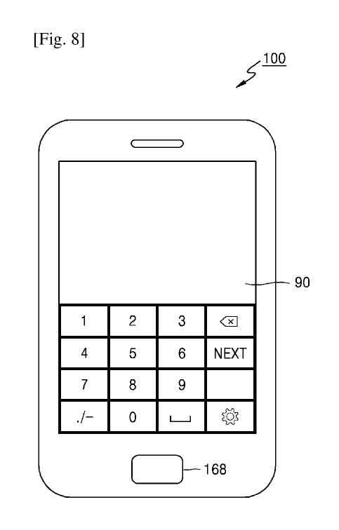

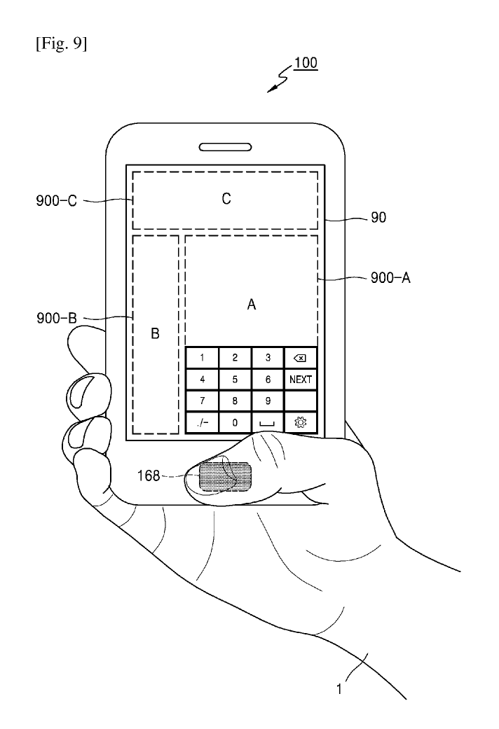

FIGS. 8 through 10 illustrate conceptual diagrams of the mobile terminal 100 for displaying a UI, according to some exemplary embodiments. Referring to FIG. 8, according to some exemplary embodiment, the mobile terminal 100 may display a UI. A UI refers to a device or software via which a user may input a command for controlling the mobile terminal 100. For example, the mobile terminal 100 may display a virtual key pad, an application execution icon list, or a menu button via the display unit 90.

Referring to FIG. 9, if a user 1 contacts the fingerprint recognition module 168 with a fingerprint of his/her right hand, the mobile terminal 100 may determine an area A 900-A of the display unit 90 as a manipulation area. The mobile terminal 100 may display a UI on the area A 900-A so that the user 1 may easily input a command via the UI. The mobile terminal 100 may display information on an area B 900-B or an area C 900-C, instead of a UI that was originally to be displayed.

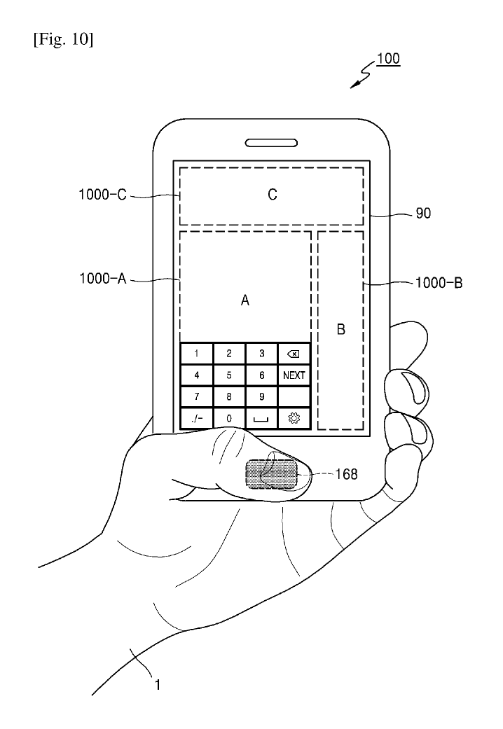

Referring to FIG. 10, if the user 1 contacts the fingerprint recognition module 168 with a fingerprint of his/her left hand, the mobile terminal 100 may determine an area A 1000-A of the display unit 90 as a manipulation area. The mobile terminal 100 may display a UI on the area A 1000-A so that the user 1 may easily input a command via the UI. The mobile terminal 100 may display information on an area B 1000-B or an area C 1000-C, other than a UI that was originally to be displayed.

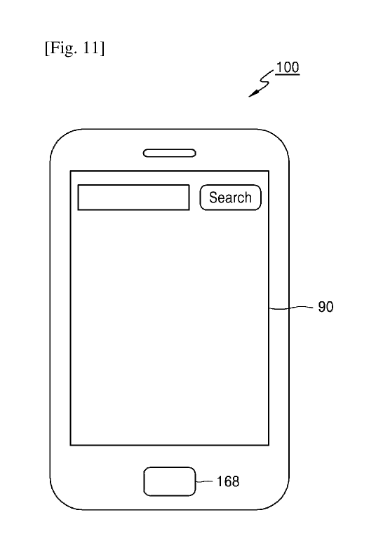

FIGS. 11 through 13 illustrate conceptual diagrams of the mobile terminal 100 for displaying an application execution screen, according to some exemplary embodiments. Referring to FIG. 11, the controller 110 included in the mobile terminal 100 executes an application, and display an application execution screen on the display unit 90. For example, the mobile terminal 100 may execute a web browser, and display the web browser on the display unit 90.

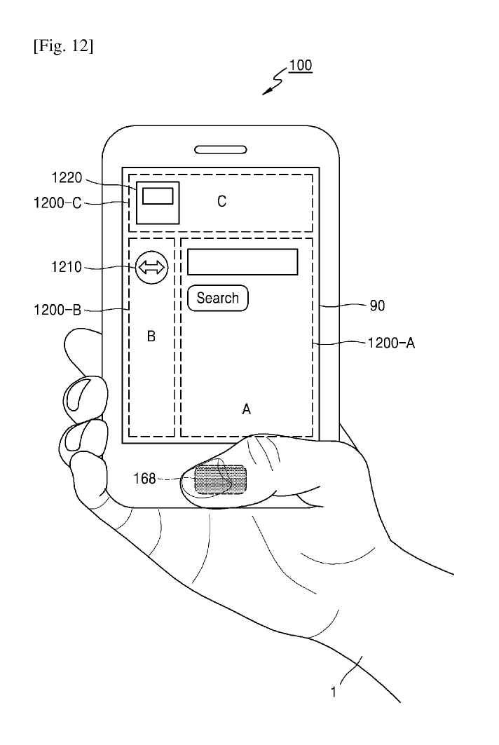

Referring to FIG. 12, if the user 1 contacts the fingerprint recognition module 168 with a fingerprint of his/her right hand, the mobile terminal 100 may determine an area A 1200-A of the display unit 90 as a manipulation area. The mobile terminal 100 may display an application execution screen on the area A 1200-A so that the user 1 may easily input to an application. Generally, the manipulation area obtained by the determining is smaller than an area of the application execution screen displayed on a whole area of the display unit 90. The mobile terminal 100 may reduce an area of the application executed screen, so that the application execution screen is displayed on the manipulation area of the display unit 90. Alternatively, the mobile terminal 100 may display only a part of the application execution screen on the manipulation area of the display unit 90. Alternatively, the mobile terminal 100 may reconfigure the application execution screen, and display the reconfigured application execution screen on the manipulation area. For example, the mobile terminal 100 may form a list of link information displayed on a web browser, and display only the link information on the manipulation area. However, displaying of an application execution screen is not limited thereto.

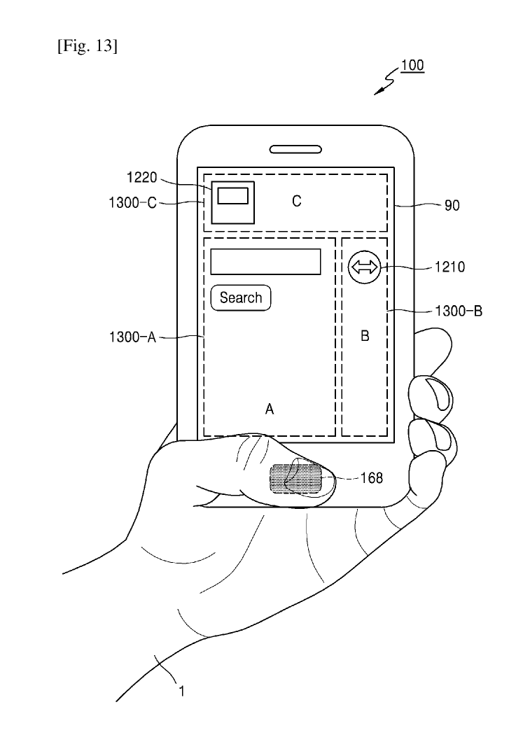

The mobile terminal 100 may display information on an area B 1200-B or an area C 1200-C, instead of a UI that was originally to be displayed. For example, the mobile terminal 100 may display a manipulation button 1210 for changing a manipulation area in the area B 1200-B. If the user 1 selects the manipulation button 1210, the mobile terminal 100 may change the application execution screen as shown in FIG. 13. As another example, if a part of the application execution screen is displayed on a manipulation area, the mobile terminal 100 may display an image, which indicates an area of the displayed part of the application execution screen from among the whole application execution screen, on the area C 1200-C. Alternatively, the mobile terminal 100 may display a rate, at which a screen displayed on a manipulation area is reduced, on the area B 1200-B or the area C 1200-C. Information displayed on the area B 1200-B or the area C 1200-C may be variously modified according to exemplary embodiments.

Referring to FIG. 13, if the user 1 contacts the fingerprint recognition module 168 with a fingerprint of his/her hand, the mobile terminal 100 may determine an area A 1300-A of the display unit 90 as a manipulation area. The mobile terminal 100 may display an application execution screen on the area A 1300-A so that the user 1 may easily input to an application. Generally, the manipulation area obtained by the determining is smaller than an area of the application execution screen displayed on a whole area of the display unit 90. The mobile terminal 100 may reduce an area of the application executed screen, so that the application execution screen is displayed on the manipulation area of the display unit 90. Alternatively, the mobile terminal 100 may display only a part of the application execution screen on the manipulation area of the display unit 90. Alternatively, the mobile terminal 100 may reconfigure the application execution screen, and display the reconfigured application execution screen on the manipulation area. For example, the mobile terminal 100 may form a list of link information displayed on a web browser, and display only the link information on the manipulation area. However, displaying of an application execution screen is not limited thereto.

The mobile terminal 100 may display information on an area B 1300-B or an area C 1300-C, instead of a UI that was originally to be displayed. For example, the mobile terminal 100 may display the manipulation button 1210 for shifting a manipulation area in the area B 3200-B. If the user 1 selects the manipulation button 1210, the mobile terminal 100 may shift the application execution screen as shown in FIG. 12. As another example, if a part of the application execution screen is displayed on the manipulation area, the mobile terminal 100 may display an image, which indicates an area of the displayed part of the application execution screen from among the whole application execution screen, on the area C 1300-C. Alternatively, the mobile terminal 100 may display a rate, at which a screen displayed on the manipulation area is reduced, on the area B 1300-B or the area C 1300-C. Information displayed on the area B 1300-B or the area C 1300-C may be variously modified according to exemplary embodiments.

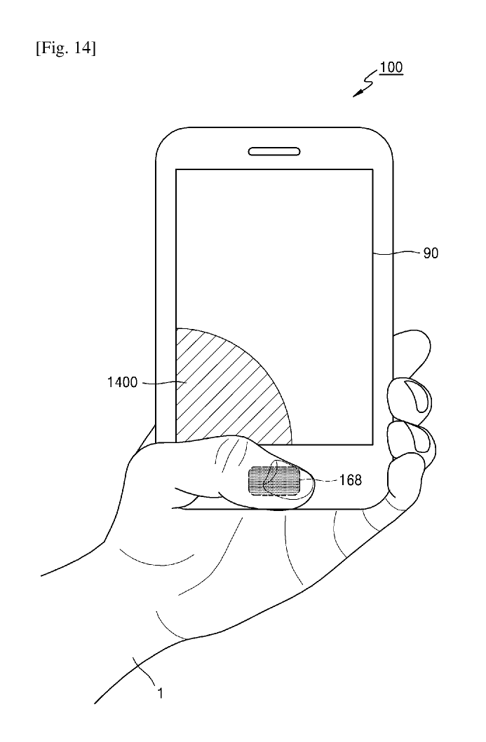

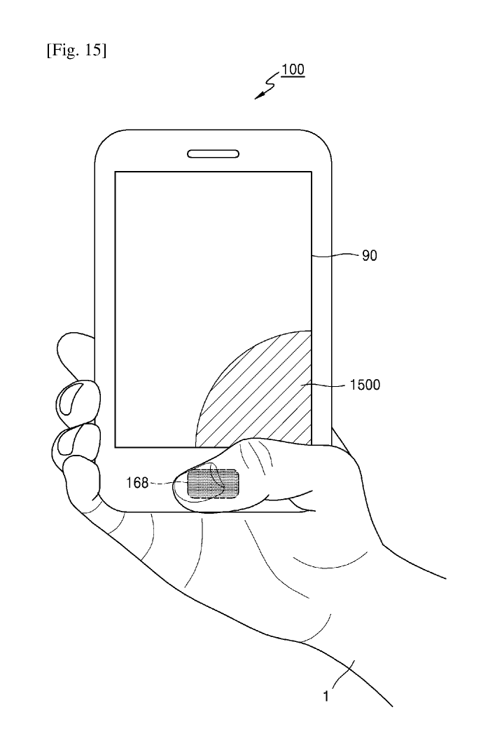

The manipulation area is not limited to the forms shown in FIGS. 9, 10, 12, and 13. For example, FIGS. 14 and 15 illustrate conceptual diagrams of a manipulation area according to other exemplary embodiments. Referring to FIG. 14, if a fingerprint of the left hand of the user 1 is input via the fingerprint recognition module 168, the mobile terminal 100 may determine a manipulation area 1400 as shown in FIG. 14. Additionally, referring to FIG. 15, if a fingerprint of the right hand of the user 1 is input via the fingerprint recognition module 168, the mobile terminal 100 may determine a manipulation area 1500 as shown in FIG. 15.

FIG. 2 illustrates a schematic block diagram of a structure of the mobile terminal 100 according to some exemplary embodiments. FIG. 2 shows only the mobile terminal 100 according to some exemplary embodiments. The mobile terminal 100 may include more or less elements than those shown in FIG. 2. Alternatively, the elements shown in FIG. 2 may be substituted by other similar elements.

The mobile terminal 100 may be connected to an external apparatus (not illustrated) by using a mobile communication module 120, a sub-communication module 130, and a connector 165. The external apparatus may include at least one selected from the group consisting of a cellular phone (not illustrated), a smartphone (not illustrated), a tablet personal computer (PC) (not illustrated), and a server (not illustrated), but an element that may be include in the external apparatus is not limited thereto.

Referring to FIG. 2, the display apparatus 100 may include the display unit 90. The display unit 90 may include a touchscreen 190 and a touchscreen controller 195. Additionally, the mobile terminal 100 may include the controller 110, the mobile communication module 120, the sub-communication module 130, a multimedia module 140, a camera module 150, a global positioning module (GPS) 155, an input/output (I/O) module 160, a sensor module 170, a storage unit 175, and a power-supply unit 180. The sub-communication module 130 may include at least one selected from the group consisting of a wireless local area network (WLAN) module 131 and a short-range communication module 132. The multimedia module 140 may include at least one selected from the group consisting of a broadcast communication module 141, an audio playback module 142, and a video playback module 143. The camera module 150 may include at least one selected from the group consisting of a first camera 151 and a second camera 152. The I/O module 160 may include at least one selected from the group consisting of one or more buttons 161, a microphone 162, a speaker 163, a vibration motor 164, a connector 165, and a keypad 166. The I/O module 160 may include the fingerprint recognition module 168.

The controller 110 may include a central processing unit (CPU) 111, a read-only memory (ROM) in which a control program for controlling the mobile terminal 100 is stored, and a random access memory (RAM) that memorizes a signal or data input from an outside of the mobile terminal 100 or is used as a memory area for work performed by the mobile terminal 100. The CPU 111 may include a plurality of processors such as a single-core type, a dual-core type, a triple-core type, or a quadcore type. The CPU 111, the ROM 112, and the RAM 113 may be connected to each other via an internal bus.

The controller 110 may control the mobile communication module 120, the subcommunication module 130, the multimedia module 140, the camera module 150, the GPS 155, the I/O module 160, the sensor module 170, the storage unit 175, the power-supply unit 180, and the display unit 90.

The mobile communication module 120 may connect the mobile terminal 100 to an external apparatus via mobile communication by using at least one (one or more) antenna (not illustrated) according to a control by the controller 110. The mobile communication module 120 may transceive a wireless signal for a voice phone call, a video phone call, short message service (SMS) communication, or multimedia message service (MMS) communication with a cellular phone (not illustrated), a smartphone (not illustrated), a tablet PC (not illustrated), or another similar apparatus (not illustrated) having a phone number that may be input to the mobile terminal 100.

The sub-communication module 130 may include at least one selected from the group consisting of the WLAN module 131 and the short-range communication module 132. For example, the sub-communication module 130 may include either the WLAN module 131 or the short-range communication module 132, or both the WLAN module 131 and the short-range communication module 132.

The WLAN module 131 may be connected to the Internet in a location where a wireless access point (AP) (not illustrated) is installed, according to a control by the controller 110. The WLAN module 131 may support IEEE802.11x, a WLAN standard by the Institute of Electrical and Electronics Engineers (IEEE). The short-range communication module 132 may wirelessly perform short-range communication between the mobile terminal 100 and an image-forming apparatus (not illustrated) according to a control by the controller 110. A method of short-range communication may include a Bluetooth communication method, an infrared data association (IrDA) communication method, or a Zigbee communication method.

The mobile terminal 100 may include at least one selected from the group consisting of the mobile communication module 120, the WLAN module 131, and the short-range communication module 132, according to performance of the mobile terminal 100.

The multimedia module 140 may include the broadcasting communication module 141, the audio playback module 142, and the video playback module 143. The broadcasting communication module 141 may receive a broadcasting signal, for example, a TV broadcasting signal, a radio broadcasting signal, or a data broadcasting signal and broadcasting additional information, for example, an electric program guide (EPG) or an electric service guide (ESG) which are transmitted from a broadcasting station via a broadcasting communication antenna (not illustrated) according to a control by the controller 110. The audio playback module 142 may play a digital audio file stored or received according to a control by the controller 110. The video playback module 143 may play a digital video file stored or received according to a control by the controller 110. The video playback module 143 may play a digital audio file.

The multimedia module 140 may include the audio playback module 142 and the video playback module 143, other than the broadcasting communication module 141. Additionally, the audio playback module 142 or the video playback module 143may be included in the controller 100.

The camera module 150 may include at least one selected from the group consisting of a first camera 151 and a second camera 152 for capturing a still image or a moving image according to a control by the controller 110. Additionally, the first camera 151 or the second camera 152 may include an auxiliary light source (not illustrated) for providing an amount of light necessary for capturing an image. The first camera 151 is disposed at a front surface of the mobile terminal 100, and the second camera 152 may be disposed at a rear surface of the mobile terminal 100. Alternatively, the first camera 151 and the second camera 152 may be disposed to be adjacent to each other, for example, with a distance greater than 1 cm and less than 8 cm therebetween, and thus, capture a three-dimensional (3D) still image or a 3D moving image.

The GPS module 155 may receive a radio wave from a plurality of GPS satellites (not illustrated) in the Earth's orbit, and calculate a location of the mobile terminal 100 by using a time of arrival of the radio wave from the GPS satellite (not illustrated) to the display apparatus 100.

The I/O module 160 may include at least one from the group consisting of the plurality of buttons 161, the microphone 162, the speaker 163, the vibration motor 164, the connector 165, the keypad 166, and the fingerprint recognition module 168.

The plurality of buttons 161 may be formed on a front surface, a side surface, or a rear surface of a housing of the mobile terminal 100, and may include at least one selected from the group consisting of a power/lock button (not illustrated), a volume button (not illustrated), a menu button, a home button, a back button, and a search button.

The microphone 162 may receive an input of voice or sound, and thus, generate an electric signal according to a control by the controller 110.

The speaker 163 may output sound corresponding to various signals from the mobile communication module 120, the sub-communication module 130, the multimedia module 140, or the camera module 150 to outside the mobile terminal 100 according to a control by the controller 110. The speaker 163 may output sound corresponding to a function performed by the mobile terminal 100. A single or a plurality of speakers 163 may be formed on an appropriate location or locations of the housing of the mobile terminal 100.

The vibration motor 164 may convert an electrical signal into mechanical vibration according to a control by the controller 110. For example, if the mobile terminal 110 in a vibration mode receives a voice call from another apparatus (not illustrated), the vibration motor 164 may operate. The vibration motor 165 may operate in a response to a touch operation by a user on the touchscreen 190 or continuous movement of a touch input to the touchscreen 190.

The connector 165 may be used as an interface for connecting the mobile terminal 100 to an external apparatus (not illustrated) or a power source (not illustrated). Data stored in the storage unit 175 included in the mobile terminal 100 may be transmitted to or received from an external apparatus (not illustrated) via a wired cable connected to the connector 165 according to a control by the controller 110. The mobile terminal 100 may receive power from or a battery (not illustrated) may be charged by the power source (not illustrated) via the wired cable connected to the connector 165.

The key pad 166 may receive a key input from a user so as to control the mobile terminal 100. The key pad 166 includes a physical key pad (not illustrated) formed on the mobile terminal 100 or a virtual key pad (not illustrated) displayed on the touchscreen 190. The physical key pad (not illustrated) formed on the mobile terminal 100 may not be included in the mobile terminal 100 according to performance or a structure of the mobile terminal 100.

The fingerprint recognition module 168 may include a fingerprint recognition sensor for generating fingerprint image data by recognizing a fingerprint of a user. The fingerprint recognition sensor may be disposed at various locations in the mobile terminal 100. For example, the fingerprint recognition sensor may be placed on at least one selected from the group consisting of a home button, a side surface, and a rear surface of the mobile terminal 100. The fingerprint recognition sensor may be implemented as an optical type or a semiconductor type, but is not limited thereto.

According to some exemplary embodiments, the fingerprint recognition module 168 may compare an electric signal, output when a fingerprint of a user contacts an outer surface of the fingerprint recognition module, to a reference voltage, and generate fingerprint image data consisting of binary data indicating whether the electric signal corresponds to a ridge of the fingerprint or a valley of the fingerprint.

The fingerprint recognition module 168 may be formed as one body with another element of the I/O module 160. For example, the fingerprint recognition module 168 may be formed as one body with the home button from among the plurality of buttons 162. In this case, the fingerprint recognition module 168 may recognize a fingerprint when the home button is pushed.

The sensor module 170 includes at least one sensor for detecting a state of the mobile terminal 100. For example, the sensor module 170 may include a proximity sensor (not illustrated) for detecting whether a user is near the mobile terminal 100, an illumination sensor (not illustrated) for detecting an amount of light near the mobile terminal 100, or a motion sensor (not illustrated) for detecting a motion of the mobile terminal 100, for example, a rotation of the mobile terminal 100, or acceleration or vibration exerted on the mobile terminal 100. A sensor included in the sensor module 170 may be added or deleted according to performance of the mobile terminal 100. According to some exemplary embodiments, the fingerprint recognition module 168 may be included in the sensor module 170, instead of in the I/O module 160.

The storage unit 175 may include a signal or data that is input/output in correspondence with an operation of the mobile module 120, the sub-communication 130, the multimedia module 140, the camera module 150, the GPS module 155, the I/O module 160, the sensor module 170, or the touchscreen 190. The storage unit 175 may store a control program and applications for controlling the mobile terminal 100 or the controller 110.

A storage unit described herein may include the storage unit 175, the ROM 112 or the RAM 113 included in the controller 110, or a memory card (not illustrated) mounted in the mobile terminal 100. The storage unit may include a non-volatile memory, a volatile memory, a hard-disk drive (HDD), or a solid-state drive (SSD).

According to some exemplary embodiments, the storage unit 175 may constitute the fingerprint database 175-1. In this case, the storage unit 175 may store information about a fingerprint signature.

The power-supply unit 180 may supply power from at least one battery (not illustrated) disposed in the housing of the mobile terminal 100 to each element of the mobile terminal 100, according to a control by the controller 110. Additionally, the power-supply unit 180 may supply power input from an external power source (not illustrated) to each element of the mobile terminal 100 via the wired cable connected to the connector 165.

The touchscreen 190 may output a UI corresponding to various services to a user. The touchscreen 190 may transmit an analog signal, which corresponds to at least one touch input to the UI, to the touchscreen controller 195. The touchscreen 190 may receive at least one touch input from a physical body of a user or an input unit that may touch the touchscreen 190, for example, a stylus pen. Additionally, the touchscreen 190 may receive continuous movement of at least one touch input. The touchscreen 190 may transmit an analog signal, which corresponds to the continuous movement of the at least one touch input, to the touchscreen controller 195.

A touch input described herein is not limited to an input by a contact of a physical body of a user or an input unit that may touch the touchscreen 190 with the touchscreen 190, and may include a non-contact input, for example, an input that is made when a distance between the touchscreen 190 and a physical body of a user is less than 1 mm. A distance between the touchscreen 190 and a physical body of a user or an input unit, within which the touchscreen 190 may detect a non-contact (or proximity) input, may vary according to performance or a structure of the mobile terminal 100.

The touchscreen 190 may be implemented as, for example, a resistive type, a capacitive type, an infrared type, or an ultrasound wave type.

The touch screen controller 195 may convert an analog signal received from the touch screen 190 into a digital signal, for example, X and Y coordinates and transmit the digital signal to the controller 110. The controller 110 may control the touchscreen 190 by using a digital signal received from the touchscreen controller 195. For example, the controller 110 may select an application execution icon (not illustrated) displayed on the touchscreen 190 or execute an application, in a response to a touch input. The touch screen controller 195 may be included in the touchscreen 190 or the controller 110.

FIG. 4 illustrates a flowchart of a process of controlling the mobile terminal 100 according to some exemplary embodiments.

In operation S410, the mobile terminal 100 may register a plurality of fingerprint signatures for the fingerprint database 175-1. A fingerprint signature refers to information for determining a fingerprint corresponding to signature image data. The mobile terminal 100 may register a fingerprint signature for the fingerprint database 175-1, based on fingerprint image data generated by the fingerprint recognition module 168.

According to some exemplary embodiments, the mobile terminal 100 may differentiate a fingerprint signature of a left hand with a fingerprint signature of a right hand so as to register a fingerprint. Referring to FIG. 6, the mobile terminal 100 may classify a fingerprint signature according to a finger, and register the fingerprint signature for the fingerprint database 175-1. Additionally, the mobile terminal 100 may classify and register fingerprint signatures of a plurality of users.

Then, in operation S420, the mobile terminal 100 may generate fingerprint image data by using the fingerprint recognition module 168. The fingerprint recognition module 168 may include a fingerprint recognition sensor for generating fingerprint image data by recognizing a fingerprint of a user. The fingerprint recognition sensor may be disposed at various locations in the mobile terminal 100. For example, the fingerprint recognition sensor may be located on at least one selected from the group consisting of a home button, a side surface, and a rear surface of the mobile terminal 100. The fingerprint recognition sensor may be implemented as an optical type sensor or a semiconductor-type sensor, but is not limited thereto.

According to some exemplary embodiments, the fingerprint recognition module 168 may compare an electric signal, output when a fingerprint of a user contacts an outer surface of the fingerprint recognition module, to a reference voltage, and generate fingerprint image data consisting of binary data indicating whether the electric signal corresponds to a ridge of the fingerprint or a valley of the fingerprint.

Then, in operation S430, the mobile terminal 100 may determine a fingerprint signature corresponding to the fingerprint image data. The mobile terminal 100 may compare the fingerprint image data to each of the plurality of fingerprint signatures registered for the fingerprint database 175-1. The mobile terminal 100 may obtain a correlation value with respect to a correlation between the fingerprint image data and each of the plurality of fingerprint signatures, based on a result of the comparing. The correlation value may refer to a value indicating a degree in which the fingerprint image data matches a fingerprint signature. The mobile terminal 100 may determine a fingerprint signature having a highest correlation value as a fingerprint signature corresponding to the fingerprint image data.

Then, in operation S440, the mobile terminal 100 may execute a process corresponding to the determined fingerprint signature. According to some exemplary embodiments, the mobile terminal 100 may determine a process to be executed, based on whether the fingerprint signature corresponding to the fingerprint image data is included in a left hand or a right hand. Alternatively, according to other exemplary embodiments, if a process corresponding to a fingerprint signature is stored in the fingerprint database 175-1, the mobile terminal 100 may determine a process to be executed, based on the fingerprint database 175-1. A method of determining a process to be executed based on a fingerprint signature, which is performed by the mobile terminal 100, may be variously modified. For example, if the fingerprint image data generated in operation S430 corresponds to a fingerprint of a right hand, the mobile terminal 100 may display a UI or an application execution screen on the display unit 90 in operation S440, as shown in FIG. 9 or 12.

Drawings provided herein illustrate only embodiments in which the mobile terminal 100 displays a UI or an application execution screen on the display unit 90 in operation S440. However, the process that may be executed by the mobile terminal 100 in operation 5440 may include all operations that may be executed by the mobile terminal 100. For example, if a fingerprint of a ring finger of a left hand is recognized, the mobile terminal 100 may perform a process of executing a schedule management application or a process of transmitting data to an external device.

FIG. 7 illustrates a flowchart of a method of recognizing a fingerprint and displaying a UI corresponding to the fingerprint, the method being performed by the mobile terminal 100, according to some exemplary embodiments.

In operation S710, the mobile terminal may recognize a fingerprint by using the fingerprint recognition module 168. In operation 5710, the fingerprint recognition module may generate fingerprint image data.

Then, in operation S720, the mobile terminal 100 may compare the fingerprint image data to each of fingerprint signatures registered for the fingerprint database 175-1. In operation 5720, the mobile terminal 100 may determine a fingerprint signature corresponding to the fingerprint image data, by comparing the fingerprint image data to the fingerprint signatures. According to some exemplary embodiments, the mobile terminal 100 may obtain a correlation value with respect to a correlation between the fingerprint image data and each of the fingerprint signatures, based on a result of the comparing in operation S720.

It may be determined whether a fingerprint signature corresponding to the fingerprint recognized in operation S710, from among fingerprint signatures registered for the fingerprint database 175-1, is present in operation S730. According to some exemplary embodiments, if a fingerprint of which a correlation value is greater than a threshold value, from among correlation values obtained in operation S720, is present, the mobile terminal 100 may determine that a fingerprint signature corresponding to the recognized fingerprint is present.

If a fingerprint signature corresponding to the fingerprint recognized in operation S710, from among the fingerprint signatures registered for the fingerprint database 175-1, is not present, the mobile terminal 100 may receive an input of a fingerprint again in operation S715. In operation S715, the mobile terminal 100 may output a message requesting a user to reinput the fingerprint. When the fingerprint is reinput, the mobile terminal 100 may perform operation S720 based on a reinput fingerprint.

If a fingerprint signature corresponding to the fingerprint recognized in operation S710, from among the fingerprint signatures registered for the fingerprint database 175-1, is present, the mobile terminal 100 may determine a type of the fingerprint signature in operation S740. A type of the fingerprint signature may indicate a type of a fingerprint of the user 1. For example, the fingerprint signature may correspond to one selected from among a first fingerprint signature, a second fingerprint signature, and a third fingerprint signature. The first fingerprint signature may indicate that the fingerprint signature corresponds to a fingerprint of a thumb of a left hand of the user 1. The second fingerprint signature may indicate that the fingerprint signature corresponds to a fingerprint of a thumb of a right hand of the user 1. The third fingerprint signature may indicate that the fingerprint signature corresponds to neither the first fingerprint signature nor the second fingerprint signature.

Then, if the fingerprint signature is the first fingerprint signature, the mobile terminal 100 may display a UI for a left hand on the display unit 90 as shown in FIG. 10. Alternatively, if the fingerprint signature is the second fingerprint signature, the mobile terminal 100 may display a UI for a right hand on the display unit 90 as shown in FIG. 9. Alternatively, if the fingerprint signature is the third fingerprint signature, the mobile terminal 100 may display a general UI on the display unit 90 as shown in FIG. 8.

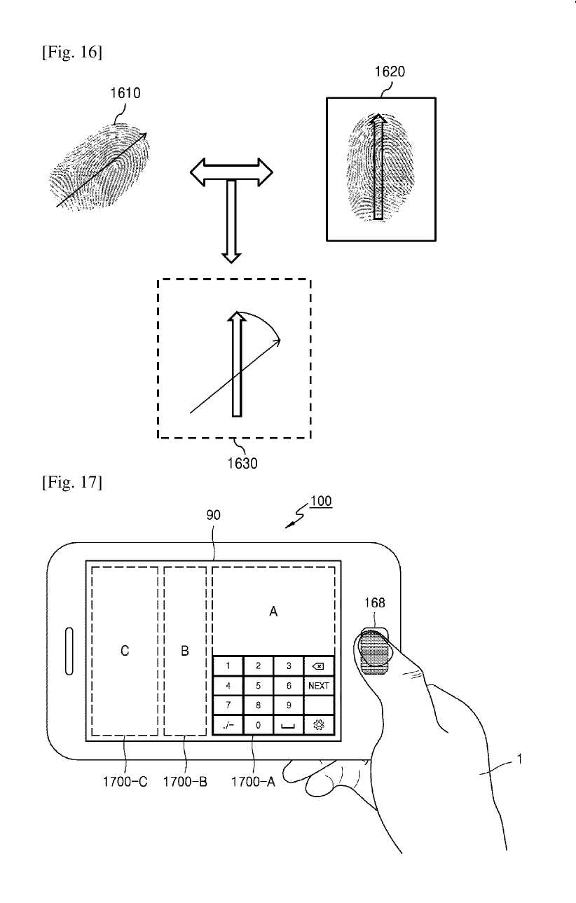

FIG. 16 illustrates a conceptual diagram of a method of determining a direction of a recognized fingerprint, according to some exemplary embodiments. Even if a fingerprint corresponds to a fingerprint signature 1620, a direction and a location in which the user 1 contacts the fingerprint recognition module 168 with his/her finger are not consistent. Accordingly, fingerprint image data 1610 or the fingerprint signature 1620 may need to be rotated or moved to compare the image data 1610 to the fingerprint signature 1620. Accordingly, in operation S430, the controller 110 included in the mobile terminal 110 may compare the fingerprint image data to the fingerprint signature after rotating the fingerprint image data, so as to determine a fingerprint signature corresponding to the fingerprint image data.

The controller 110 included in the mobile terminal 110 may determine an angle, at which the fingerprint image data 1610 or the fingerprint signature 1620 is rotated so that the fingerprint image data 1610 matches the fingerprint signature 1620 , as a direction of a fingerprint included in the fingerprint image data. The angle 1630 at which the fingerprint image data 1610 is rotated may refer to an angle at which a fingerprint in the fingerprint image data 1610 is rotated from a direction in which the fingerprint was originally recognized. The angle 1630 at which the fingerprint signature 1620 is rotated may refer to an angle at which the fingerprint signature 1620 is rotated from the fingerprint signature stored in the fingerprint database 175-1. For example, the controller 110 may incrementally rotate the fingerprint image data 1610 by 1 degree each time, and compare a fingerprint to the rotated fingerprint image data 1610 each time the fingerprint image data 1610 is rotated. The controller 110 may repeatedly obtain a correlation value based on a result of the comparing. Then, the controller 110 may determine an angle of rotation having a highest correlation value as a direction of the fingerprint.

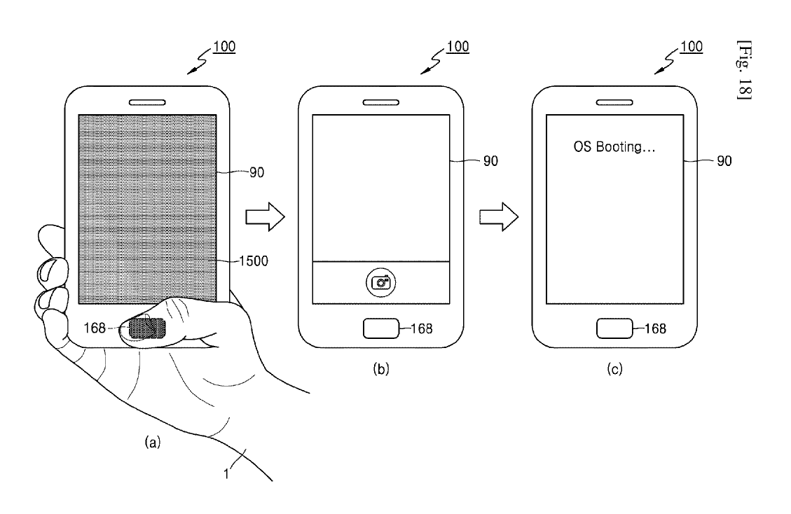

FIG. 17 illustrates a conceptual diagram of the mobile terminal 100 for displaying a UI, according to some exemplary embodiments. The mobile terminal 100 may generate fingerprint image data by using the fingerprint recognition module 168. According to some exemplary embodiments, the controller 110 included in the mobile terminal 100 may determine the process that is to be executed in operation S440 described with reference to FIG. 4, based on a direction of a fingerprint included in the fingerprint image data.

For example, as shown in FIG. 17, if a direction of a fingerprint is within a range in which it is determined that the user 1 holds the mobile terminal 100 as shown in FIG. 17, the controller 110 may determine an area A 1700-A as a manipulation area. In this case, the controller 110 may display a UI in a widthwise direction on the area A 1700-A.

Alternatively, if a direction of a fingerprint is within a range in which it is determined that the user 1 holds the mobile terminal 100 as shown in FIG. 9 or 10, the controller 110 may determine the area A 900-A or 1000-A as a manipulation area. In this case, the controller 110 may display a UI in a lengthwise direction on the area A 900-A or 1000-A.

FIGS. 18A through 18C illustrate conceptual diagrams of a method of executing a process corresponding to a state of the mobile terminal 100 and a recognized finger print, the method being performed by the mobile terminal 100, according to some exemplary embodiments.

Even when a same signature is recognized, the controller 110 included in the mobile terminal 100 may execute a different process according to a state of the mobile terminal 100. A state of the mobile terminal 100 refers to a state when the mobile terminal 100 is operating. A state of the mobile terminal 100 may include a power ON/OFF state of the mobile terminal 100, an application being executed by the mobile terminal 100, or a screen displayed on the mobile terminal 100.

The mobile terminal 100 may execute an application corresponding to a state of the mobile terminal 100 and a fingerprint signature. After the application corresponding to the state of the mobile terminal 100 and the fingerprint signature is executed, the mobile terminal 100 may boot an operating system (OS) of the mobile terminal 100. For example, as shown in FIG. 18 (a), when power of the mobile terminal 100 is in an OFF state, a fingerprint of the user 1 may be recognized via the fingerprint recognition module 168. In this case, as shown in FIG. 18 (b), the mobile terminal 100 may drive some functions of the mobile terminal 100 to drive only a camera function, before an operating system (OS) is loaded to a main memory of the mobile terminal 100 by booting the mobile terminal 100. As shown in FIG. 18(c), the mobile terminal 100 may boot the mobile terminal 100 after the camera function is driven.

In addition, other exemplary embodiments can also be implemented through computer readable code/instructions in/on a medium, e.g., a computer readable medium, to control at least one processing element to implement any above described exemplary embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments. For example, each component described in singular form may be executed in a distributed form. Likewise, components described in a distributed form may be executed in a combined form.

While one or more exemplary embodiments have been described with reference to the figures, it will be understood by those of ordinary skill in the art that various changes in form and details may be made therein without departing from the spirit and scope as defined by the following claims.

1. A method of controlling a mobile terminal, the method comprising:
registering a plurality of fingerprint signatures for a fingerprint database;
generating fingerprint image data by using a fingerprint recognition module included in the mobile terminal;
determining a fingerprint signature that corresponds to the fingerprint image data, from among the plurality of fingerprint signatures; and
executing a process corresponding to the determined fingerprint signature.

2. The method of claim 1, wherein the registering of the plurality of fingerprint signatures comprises registering the plurality of fingerprint signatures by differentiating a fingerprint of a left hand from a fingerprint of a right hand, and
the executing of the process corresponding to the determined fingerprint signature comprises:
executing a first process if the determined fingerprint signature is the fingerprint of the left hand; and
executing a second process if the determined fingerprint signature is the fingerprint of the right hand,
wherein the first process and the second process are different from each other.

3. The method of claim 1, wherein the executing of the process corresponding to the determined fingerprint signature comprises:
determining a manipulation area of a display unit included in the mobile terminal, based on the determined fingerprint signature; and
displaying a user interface (UI), via which a user inputs a command to the mobile terminal, on the determined manipulation area.

4. The method of claim 3, wherein the determining of the manipulation area comprises determining the manipulation area based on a direction of a fingerprint included in the fingerprint image data.

5. The method of claim 1, wherein the executing of the process corresponding to the determined fingerprint signature comprises:
determining a manipulation area of the display unit included in the mobile terminal, based on the determined fingerprint signature; and
displaying an application execution screen on the manipulation area.

6. The method of claim 1, wherein the executing of the process corresponding to the determined fingerprint signature comprises:
determining a process corresponding to a state of the mobile terminal and the determined fingerprint signature; and
executing the determined process.

7. The method of claim 6, wherein the determining of the process comprises:
executing an application corresponding to the fingerprint signature, if the mobile terminal is in a power-off state; and
booting an operating system (OS) of the mobile terminal after the application is executed.

8. The method of claim 1, wherein the executing of the process corresponding to the determined fingerprint signature comprises displaying either a UI in a widthwise mode or a UI in a lengthwise mode on the display unit included in the mobile terminal, according to a direction of a fingerprint included in the fingerprint image data.

9. A mobile terminal comprising:
a fingerprint database configured to register a plurality of fingerprint signatures;
a fingerprint recognition module configured to generate fingerprint image data;
a controller configured to determine a fingerprint signature that corresponds to the fingerprint image data, from among the plurality of fingerprint signatures, and execute a process corresponding to the determined fingerprint signature.

10. The mobile terminal of claim 9, wherein the fingerprint database registers the plurality of fingerprint signatures by differentiating a fingerprint of a left hand from a fingerprint of a right hand, and the controller executes a first process if the determined fingerprint signature is the fingerprint of the left hand, and executes a second process if the determined fingerprint signature is the fingerprint of the right hand,
wherein the first process and the second process are different from each other.

11. The mobile terminal of claim 9, further comprising a display unit for outputting a screen,
wherein the controller determines a manipulation area of a display unit included in the mobile terminal based on the determined fingerprint signature, and displays a user interface (UI), via which a user inputs a command to the mobile terminal, on the determined manipulation area.

12. The mobile terminal of claim 11, wherein the controller controls the display unit to display the UI, via which the user inputs the command to the mobile terminal, on the determined manipulation area.

13. The mobile terminal of claim 9, further comprising a display unit for outputting an application execution screen,
wherein the controller determines a manipulation area of the display unit, based on the determined fingerprint signature, and
the display unit displays the application execution screen on the determined manipulation area.

14. The mobile terminal of claim 9, wherein the controller determines a process corresponding to a state of the mobile terminal and the determined fingerprint signature, and executes the determined process.

15. The mobile terminal of claim 14, wherein the controller executes an application corresponding to the fingerprint signature if the mobile terminal is in a power-off state, and boots an operating system (OS) of the mobile terminal after the application is executed.
